(19) United States
(12) Patent Application Publication
(10) Pub. No.: US 2008/0041209 A1
(43) Pub. Date: Feb. 21, 2008

(54) Power saw

(76) Inventor: Ming Li, Nanjing (CN)

Correspondence Address: MCDERMOTT, WILL & EMERY LLP, 227 WEST MONROE STREET, SUITE 4400, CHICAGO, IL, 60606-5096, US

(21) Appl. No.: 11/893,484

(22) Filed: Aug. 16, 2007

(30) Foreign Application Priority Data
Aug. 18, 2006 (CN) 200620076836.0

(51) Int. Cl. B26D 1/14

(52) U.S. Cl. 83/471.3

(57) ABSTRACT

The present invention provides a power saw, which comprises a base, a support arm mounted on the base, a cutting unit supported by the support arm and pivotable about a first axis to a first angle position, and a table disposed on the base for supporting a workpiece to be cut. The cutting unit comprises a cutting head which contains a cutting element, a gear box, and a motor. The gear box is positioned between and connects the cutting head and the motor. The power saw further comprises an angle indication device which comprises a first angle indication light, a control device connected to the first angle indication light, and a power source supplying power to the first angle indication light. The first angle indication light, the control device and the power source are electrically connected when the cutting unit is at the first angle position.

This application claims priority under 35 U.S.C. 119 to CN 200620076836.0 filed Aug. 18, 2006, and is hereby incorporated by reference.

### FIELD OF THE INVENTION

The present invention relates to a power saw and more particularly to a power saw which has an indication device for indicating the cutting angle.

### BACKGROUND OF THE INVENTION

Power saws usually can be used to make angled cutting to workpieces such as wood, tile and the like. To indicate the cutting angle, a scale combined with a pointer is often used, such that when angled cutting is required, the operator will adjust the angle of the power saw according to the indication of the scale. The scale is usually set at the rear of the power saw. In order to perform angled cutting at a desired angle, the user must go to the rear side of the power saw so as to observe a scale, and after the angle is set, go back to the front side to perform cutting. Such work is time consuming and results in low working efficiency. Additionally, it is inconvenient when carefully aligning the pointer to an exact desired angle on the scale during the adjustment, since the operator has to look at the scale all the time.

### SUMMARY OF THE INVENTION

The present invention has an object to provide a power saw with a cutting angle indication device, which facilitates the operator to adjust the cutting angle in a precise and efficient manner.

To achieve this object, the present invention provides a power saw, comprising a base, a cutting unit supported on the base and being pivotable with respect to the base about a first axis to a first angle position. The cutting unit comprises a cutting head which contains a cutting element, a motor, and a drive mechanism for connecting the motor and the cutting element. A first angle indication device is electrically connected to a power source when the cutting unit is at a first angle position according to the present invention. With the angle indication device, a predetermined cutting angle can be easily obtained.

### BRIEF DESCRIPTION OF THE DRAWINGS

The present invention will become more fully understood by reference to the following detailed description thereof when read in conjunction with the attached drawings, wherein:

FIG. 1 is a perspective view of a power saw of the preferred embodiment of the present invention;

FIG. 2 is a perspective view of a cutting unit of the power saw shown in FIG. 1 while the cutting unit is slant at a 22.5 degree angle position;

FIG. 3 is another perspective view of the cutting unit of FIG. 2;

FIG. 4 is an exploded perspective view of the control device of the cutting unit shown in FIG. 2;

FIG. 5 is an inside view of the control device of the cutting unit shown in FIG. 2; and

FIG. 6 is a bottom view of the control device of the cutting unit shown in FIG. 2.

### DETAILED DESCRIPTION OF THE PREFERRED EMBODIMENT

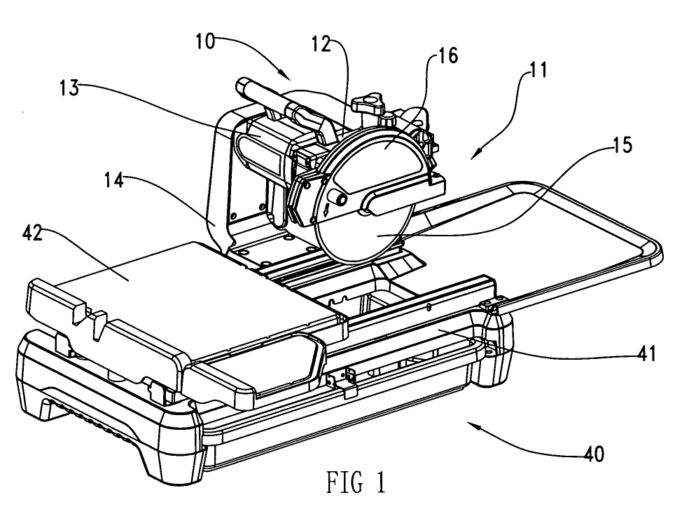

With reference to FIG. 1 of the drawing, a power saw 40 comprises a base 41, a table 42 disposed on the base 41 for supporting a workpiece, a cutting unit 10, and a support arm 14 mounted on the base 41 for supporting the cutting unit 10 above the table 42. The cutting unit 10 comprises a cutting head 11, a gear box 12, and a motor 13. A portion of the external surface of the gear box 12 is joined to the support arm 14 directly. Additionally, one end of gear box 12 is connected to the motor 13 and the other end connected to the cutting head 11. The cutting head 11 comprises a circular blade 15 and a blade guard 16. The circular blade 15 is mounted for rotation on an output shaft of the gear box 12, which is driven by the motor 13.

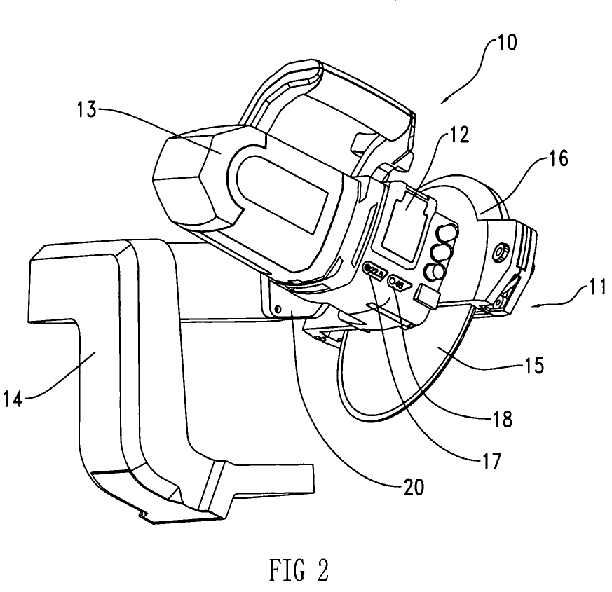

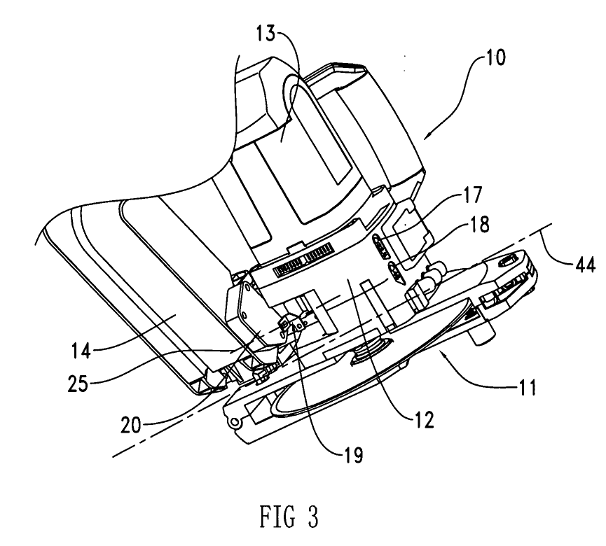

Referring to FIGS. 2 and 3, two LED angle indication lights 17, 18 marked with numbers 22.5 and 45, respectively, are mounted on a surface of the gear box 12. A LED control box 20 is fixedly mounted on the support arm 14. The cutting unit 10 is pivotally mounted on the support arm 14 around a pivot axis 44, as shown in FIG. 3. When the cutting unit 10 is slanted to a position of a 22.5 degree angle, as shown in FIG. 2, the LED angle indication light 17 marked with number 22.5 is turned on under control of the LED control box 20. If the cutting unit 10 continues to pivot off that position, the 22.5 degree LED angle indication light 17 is shut off. Likewise, when the cutting unit 10 is pivoted to a position of 45 degrees, the 45 degree LED angle indication light 18 will be turned on to notify the user of that position.

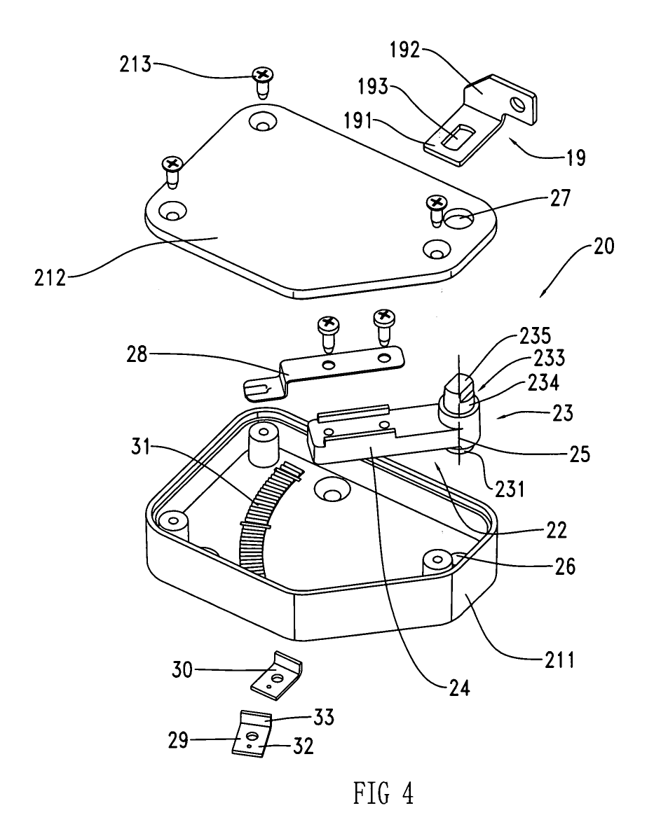

As shown in FIG. 4, the control box 20 comprises a housing 211 and a cover 212, which is mounted to the housing 211 by screws 213. A pivoting element 22, which comprises a pivot 23 and an arm 24, is pivotally mounted in the housing 211 around a pivot axis 25. Preferably, the arm 24 and the pivot 23 are integral. A bottom end 231 of the pivot 23 is rotatably mounted in a hole 26 of the housing 211, and an upper end 233 is mounted in and protrudes from a hole 27 of the cover 212. The upper end 233 comprises a first portion 234 and a second portion 235. The first portion 234 is cylindrical so as to mate with the aperture 27. The second portion 235 is partly cut to be received within an elongate slot 193 of a connecting member 19.

The control box 20 further comprises a first conductive piece 28, a second conductive piece 29, a third conductive piece 30 and an accurate scale 31. The first conductive piece 28 is mounted on the arm 24 such that it is pivotable about the axis 25 together with the arm 24, and with one end thereof sliding along the scale 31. The second conductive piece 29 and the third conductive piece 30 are mounted on the scale 31 at the 22.5 degree and 45 degree angle positions, respectively. The second conductive piece 29 and the third conductive piece 30 each have a flat part 32 and a protruding part 33. The second conductive piece 29 and the third conductive piece 30 are mounted such that the flat parts 32 thereof are mounted on the bottom surface of the housing 211 by screws. Additionally, the protruding parts 33 of second conductive piece 29 and third conductive piece 30 extend through the bottom surface of the housing 211 to a position inside of the housing 211. Thus, the protruding parts 33 can contact the first conductive piece 28 inside of housing 211. One terminal of each of the two LED angle indication lights 17, 18 is connected to the first conductive piece 28. The other terminal of the 22.5 degree LED light 17 is connected to the second conductive piece 29. Likewise, the other terminal of the 45 degree LED light 18 is connected to the third conductive piece 30. The first conductive piece 28 slides along the scale 31 when the arm 24 pivots about axis 25. When the first conductive piece 28 slides to the 22.5 degree angle position, it will contact the second conductive piece 29, such that an electrical connection is obtained and the 22.5 degree LED angle indication light 17 is turned on. Likewise, when the first conductive piece 28 slides to the 45 degree angle position, it will contact the third conductive piece 30, and the 45 degree LED angle indication light 18 is turned on as a result of an electrical connection between the two conductive pieces 28,30. Therefore, the lights 17, 18 are controlled by the electrical connection between the first conductive piece 28 and the second or third conductive pieces 29, 30, respectively.

The connecting member 19 comprises a first part 191 and a second part 192. The first part 191 connects to the second end 235 of pivot 23. The second part 192 is fixed to the gear box 12 by screws. Therefore, when gear box 12 pivots about the pivot axis 44, which also pivots cutting head 11 and motor 13, the connecting member 19 will pivot accordingly. Pivot 23 pivots along axis 25 when the gear box 12 pivots because the first part 191 of the connecting member 19 engages the second end 235 of pivot 23. Likewise, arm 24 pivots about the axis 25 when with pivot 23 pivots. The pivot amount of the arm 24 about the axis 25 is equal to the pivot amount of the gear box 12 about the axis 44, and the axis 25 is parallel to the pivot axis 44 as shown in FIG. 3.

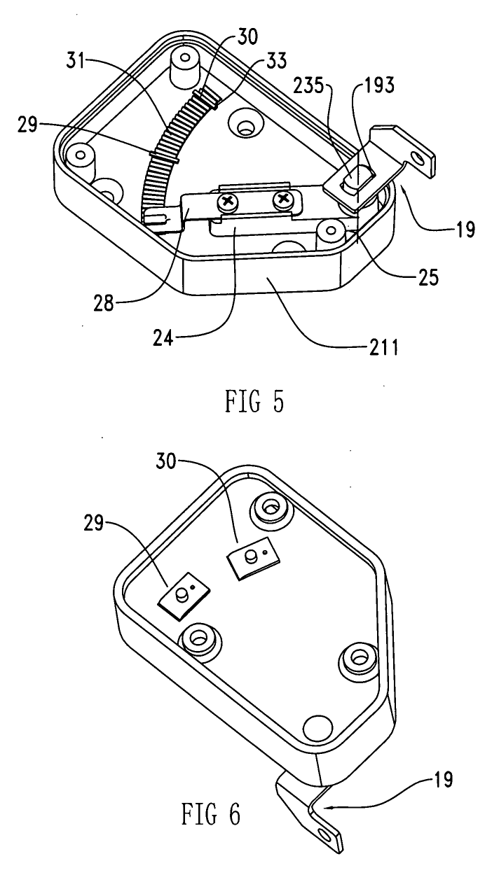

FIG. 5 shows detailed assembly of the LED control box 20. At the shown position, the first conductive piece 28 is at an initial position where the cutting unit 10 is at a vertical position and both the 22.5 degree light 17 and 45 degree LED light 18 are off. When the cutting unit 10 pivots to a position of 22.5 degrees, the arm 24 pivots an angle of 22.5 degrees accordingly and the first conductive piece 28 contacts the second conductive piece 29, and the 22.5 degree LED indication light 17 is powered by a power source (not shown). If the cutting unit 10 keeps pivoting to a position of 45 degrees, the first conductive piece 28 pivots an angle of 45 degrees and contacts the third conductive piece 30, whereupon the 45 degree LED indication light 18 is turned on indicating the 45 degree slant cutting angle.

It can be easily understood for those skilled in the art that the arm 24 and the pivot 23 of the pivoting element 22 can be of other shapes or structures, they can be integral as described above, or they can be mechanically connected. Additionally, other mechanisms may be applied to link the movements of the cutting unit and the pivoting element.

The above described preferred embodiments are intended to illuminate the principle of the present invention, but not to limit the scope thereof. It can be easily understood by those skilled in the art that many other modifications and variations of these preferred embodiments will be apparent and may be made without departing from the spirit and the scope of the invention as defined in the following claims.

We claim:

1. A power saw comprising:
a base for supporting said power saw;
a support arm mounted to the base;
a cutting unit mounted to the support arm, the cutting unit pivotable about a first axis; and
an angle indication unit connected to said support arm and said cutting unit, wherein said angle indication unit pivots about a second axis.

2. The power saw of claim 1, wherein said first angle is substantially parallel to said second angle.

3. The power saw of claim 1, wherein said angle indication unit comprises a first conductive piece and a second conductive piece.

4. The power saw of claim 3, wherein said angle indication unit powers on during contact of said first conductive piece and said second conductive piece.

5. The power saw of claim 1, wherein said angle indication unit is pivotally connected to said cutting unit by a connecting member, and said connecting member pivots said angle indication unit during pivotal movement of said cutting unit.

6. The power saw of claim 1, wherein said angle indication unit powers on upon said cutting unit reaching a predetermined angle.

7. A power saw comprising:
a base;
a support mounted to said base;
a cutting mechanism mounted to said support, the cutting mechanism pivotable about a first axis; and
an angle indicator mounted to said support, and pivotally connected to said cutting mechanism, wherein said angle indicator pivots about a second axis while said cutting mechanism pivots about said first axis.

8. The power saw of claim 8, wherein said first axis is substantially parallel to said second axis.

9. The power saw of claim 7, wherein said angle indicator powers on upon said cutting mechanism reaching a first predetermined angle.

10. The power saw of claim 9, wherein said angle indicator powers on upon said cutting mechanism reaching a second predetermined angle.

11. The power saw of claim 7, wherein said angle indicator further comprises an arm pivotally connected to said cutting mechanism, and said arm further comprises a first conductive piece mounted thereto.

12. The power saw of claim 11 wherein said angle indicator further comprises a second conductive piece mounted at a predetermined angle.

13. The power saw of claim 12, wherein said angle indicator powers on during contact of said first conductive piece and said second conductive piece.

14. A power saw comprising:
a base for supporting said power saw;
a support mounted to said base;
a cutting mechanism mounted to said support, the cutting mechanism pivotable about a first axis;
an angle indicator mounted to said support, and pivotally connected to said cutting mechanism; and
the angle indicator further comprising an arm and a shaft integrally connected, wherein said shaft is pivotally connected to said cutting mechanism, and said shaft pivots about a second axis during pivoting of said cutting mechanism about said first axis, and wherein said arm swings along an arc during pivoting of said shaft.

15. The power saw of claim 14, wherein said first axis is substantially parallel to said second axis.

16. The power saw of claim 14, wherein said arm further comprises a first conductive piece on a distal portion of said arm.

17. The power saw of claim 16, wherein said angle indicator comprises a scale adjacent said distal portion of said arm, and said scale further comprises a second conductive piece positioned along said scale at a predetermined angle.

18. The power saw of claim 17, wherein said angle indicator powers on during contact of said first conductive piece and said second conductive piece.

19. The power saw of claim 16, wherein said scale further comprises a third conductive piece along said scale at a second predetermined angle.

20. The power saw of claim 19, wherein said angle indicator powers on during contact of said first conductive piece and said third conductive piece.
